(19) United States
(12) Patent Application Publication
(10) Pub. No.: US 2002/0168249 A1
(43) Pub. Date: Nov. 14, 2002

(54) Method for binding a book

(76) Inventors: Yuval Dim, Tel Aviv (IL); Gil Rosenfeld, Beit Itzhak (IL)

Correspondence Address: Eitan, Pearl, Latzer & Cohen-Zedek, Suite 210, One Crystal Park, 2011 Crystal Drive, Arlington, VA, 22202-3709, US

(21) Appl. No.: 10/124,764

(22) Filed: Apr. 18, 2002

Related U.S. Application Data
(60) Provisional application No. 60/284,529, filed on Apr. 19, 2001.

(51) Int. Cl. B42C 9/00

(52) U.S. Cl. 412/8

(57) ABSTRACT

According to some embodiments of the invention, a method for bookbinding is provided. The method comprises placing a first hot-melt adhesive substance having a first viscosity between a central area of a spine of a book block and a corresponding area of an inner surface of a central portion of a cover for the book block. The method also comprises placing a second hot-melt adhesive substance having a second viscosity higher than the first viscosity between peripheral areas of the spine and corresponding areas of the inner surface of the central portion of the cover.

### CROSS REFERENCE TO RELATED APPLICATIONS

The present application claims priority from US provisional application Serial No. 60/284,529, filed Apr. 19, 2001.

### BACKGROUND OF THE INVENTION

Printed pages may be bound into a book using various methods, for example, using hot-melt adhesive. In this method, a hot-melt adhesive may be applied to an inner surface of a central portion of a cover or to a spine of a book block. The cover may then be positioned such that the inner surface of its central portion abuts the spine. Heat and pressure may be applied to the contact area to cause the cover and the spine to adhere. The applied heat and pressure often induce undesired leakage of adhesive from both the longitudinal ends of the spine.

In conventional bookbinding methods, the excessive adhesive may be removed by trimming the cover and pages of the bound book. However, a post-binding trimming operation is undesirable in various systems, such as, for example, in print-on-demand machines, book vending machines and office digital printers.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a schematic illustration of a book bound with a hot-melt adhesive tape according to some embodiments of the present invention;

FIG. 1B is a schematic illustration of a cover of the book of FIG. 1A;

FIG. 1C is a perspective side view of a portion of the book of FIG. 1A; and

FIG. 2 is a schematic illustration of a hot-melt adhesive tape according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

While some embodiments of the present invention will be described, for purposes of illustration only, in conjunction with a hot-melt adhesive tape, the present method is applicable also to other types of hot-melt adhesives, such as, for example, adhesive emulsions.

Some embodiments of the present invention are directed to a method for bookbinding. Hot-melt adhesives having different viscous properties in the melted state are provided to different areas on a spine of a book block. A high-viscosity hot-melt adhesive may be applied to the peripheral areas of the spine, namely the top strip and bottom strip of the spine and a low-viscosity hot-melt adhesive may be applied to the central area along the spine. The high-viscosity hot-melt adhesive may reduce the flow of low-viscosity adhesive so as to reduce or to prevent sideways leakage of adhesive. In some embodiments, a hot-melt adhesive tape is used. The hot-melt adhesive tape may comprise defined regions of a high-viscosity adhesive and a low-viscosity adhesive. In other embodiments, a non-adhesive absorbent material, for example, a sponge-like material, may be fixed to the peripheral areas of the spine.

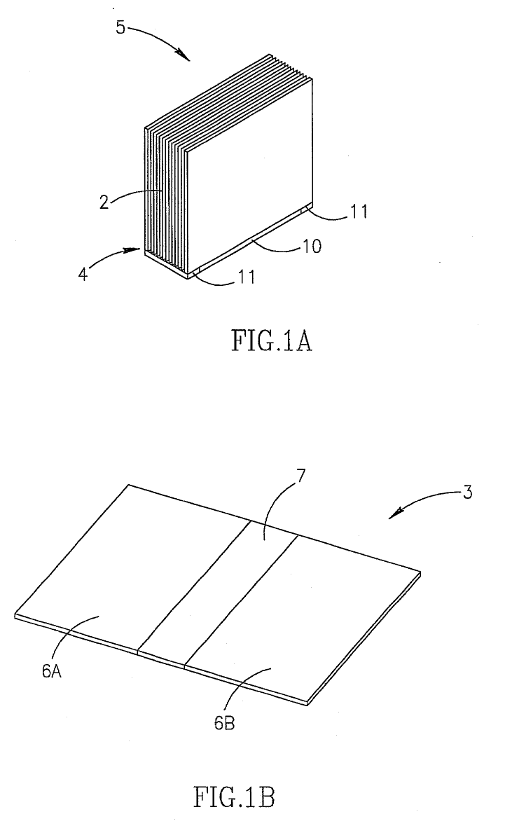

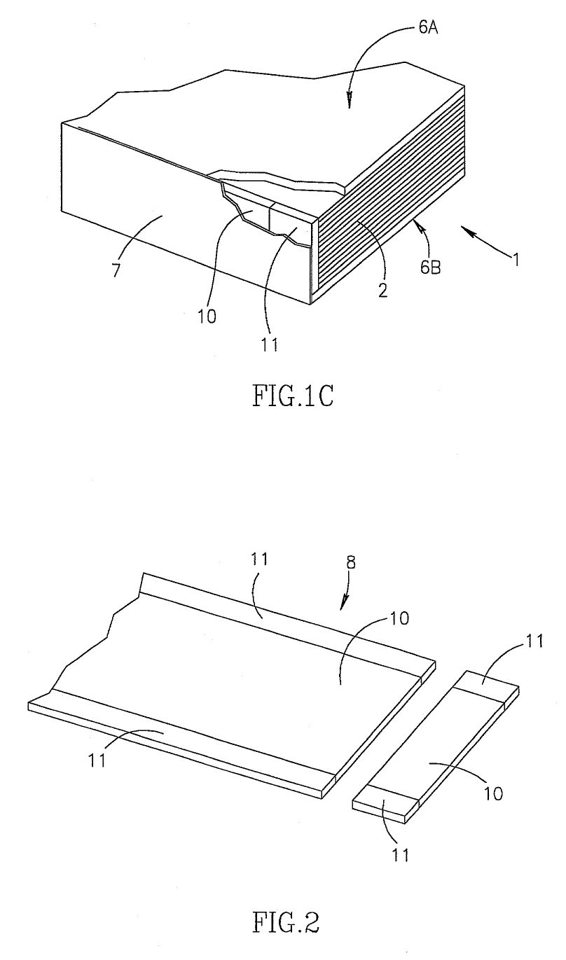

Reference is now made to FIGS. 1A-1C, which are schematic illustrations of a book bound with a hot-melt adhesive tape according to some embodiments of the present invention. FIG. 1A is a schematic illustration of a book block FIG. 1B is a schematic illustration of a cover for the book block of FIG. 1A. FIG. 1C, is a perspective side view of a portion of the book. An exemplary book 1 having a plurality of pages 2 and a cover 3 is shown. Cover 3 may comprise a front cover 6A, a back cover 6B, and a central portion 7. Pages 2 are aligned into a book block 5 having a spine 4. A hot-melt adhesive tape 8, which will be described with respect to FIG. 2, may be placed between an inner surface of central portion 7 and spine 4 causing them to adhere.

Reference is flow made to FIG. 2, which is a schematic illustration of a hot-melt adhesive tape according to some embodiments of the present invention. In the exemplary configuration, shown in FIG. 2, hot-melt adhesive tape 8 may comprise a central longitudinal band 10 and two side bands 11 along the longitudinal edges of central band 10. The widths of side band 11 may vary according to application's requirements. However, it should be noted that tape 8 may have a different configuration, such as, for example, having only one side band 11 along a longitudinal edge of band 10.

Central band 10 may comprise a low-viscosity hot-melt adhesive substance and side band 11 may comprise a high-viscosity hot-melt adhesive substance. When the high-viscosity hot-melt adhesive substance is heated, it remains highly viscous and therefore practically immobile in comparison to a low-viscosity hot-melt adhesive substance that when heated becomes fluid and tends to flow.

The low-viscosity adhesive substance may be selected according to desired properties, such as, for example, viscosity, penetration properties, wetting properties and, binding temperature and speed. Typically, tape 8 may be in a form of a roll (not shown) having a width that is generally equal to the length of pages 2 of book 1 being bound. Tape 8 is cut to a desired size at the time of use. Generally, the size to which tape 8 is cut when binding is substantially equal to the width of spine 4.

In some embodiments, side band 11 may comprise a non-adhesive absorbent substance, such as for example, a sponge-like material.

According to other embodiments of the present invention, adhesive emulsion may be applied to the spine of the cover via, for example, a nozzle fed from a pressurized storage tank. A low-viscosity adhesive emulsion may be applied to the inner portion of the spine area and consecutively or optionally simultaneously, a high-viscosity adhesive emulsion may be applied to one or two of the longitudinal ends of the spine area. Alternatively an adhesive emulsion may be applied to the inner portion of the spine area and non-adhesive absorbent material may be fixed to the peripheral areas of the spine.

While certain features of the invention have been illustrated and described herein, many modifications, substitutions, changes, and equivalents will flow occur to those of ordinary skill in the alt. It is, therefore, to be understood that the appended claims are intended to cover all such modifications and changes as fall within the true spirit of the invention.

What is claimed is:

1. A method comprising:
placing a first hot-melt adhesive substance having a first viscosity between a central area of a spine of a book block and a corresponding area of an inner surface of a central portion of a cover for said book block; and
placing a second hot-melt adhesive substance having a second viscosity higher than said first viscosity between peripheral areas of said spine and corresponding areas of said inner surface of said central portion of said cover.

2. Tie method of claim 1, further comprising:
applying heat to said first adhesive substance and said second adhesive substance.

3. A method comprising:
placing a hot-melt adhesive substance between a central area of a spine of a book block and a corresponding area of an inner surface of a central portion of a cover for said book block; and
placing a non-adhesive absorbent substance between peripheral areas of said spine and corresponding areas of said inner surface of said central portion of said cover.

4. The method of claim 3, further comprising:
applying heat to said adhesive substance.

5. A method comprising:
placing a strip of hot-melt adhesive tape between a spine of a book block and a central region of a cover, said hot-melt adhesive tape comprising a central portion comprising a first hot-melt adhesive substance having a first viscosity and side portions comprising a second hot-melt adhesive substance having a second viscosity that is higher than said first viscosity,
wherein placing said strip comprises:
positioning said side portions of said tape along a top strip of said spine and a bottom strip of said spine; and
positioning said central portion next to an inner region of said spine.

6. The method of claim 5, further comprising:
applying heat to said first adhesive substance and said second adhesive substance.

7. A hot-melt adhesive tape comprising:
a central longitudinal band comprising a first hot-melt adhesive substance having a first viscosity; and
two side bands along longitudinal edges of said central band, said side bands comprising a second hot-melt adhesive substance having a second viscosity higher than said first viscosity.

8. A hot-melt adhesive tape comprising:
a first longitudinal band comprising a first hot-melt adhesive substance having a first viscosity; and
a second longitudinal band along a longitudinal edge of said first band, said second band comprising a second hot-melt adhesive substance having a second viscosity higher than said first viscosity.

9. A hot-melt adhesive tape comprising:
a central longitudinal band comprising a hot-melt adhesive substance; and
two side bands along longitudinal edges of said central band, said side bands comprising a non-adhesive absorbent substance.
